(19) United States
(12) Patent Application Publication
(10) Pub. No.: US 2002/0135820 A1
(43) Pub. Date: Sep. 26, 2002

(54) Scanning apparatus capable of engaging an automatic document feeder

(76) Inventor: Chih-Wen Huang, Hsinchu (TW)

Correspondence Address: Raymond Sun, 12420 Woodhall Way, Tustin, CA, 92782, US

(21) Appl. No.: 09/909,922

(22) Filed: Jul. 20, 2001

(30) Foreign Application Priority Data
Mar. 22, 2001 (TW) 90204320

(51) Int. Cl. H04N 1/04

(52) U.S. Cl. 358/498

(57) ABSTRACT

The present invention relates to a scanning apparatus capable engaging an automatic document feeder. Wherein the “light” of at least one light source, through the inter-positions and corresponding relationship of angles, and after being reflected and changing direction, emits to an image retrieving unit. Among its a plurality of reflection mirrors, the scanning apparatus capable of engaging an automatic document feeder further comprising a switch-able reflection mirror, which capable of switching a first position to scan a manuscript by platform type and a second position matching with an automatic document feeder to scan a manuscript by document feeding type. When the scanning apparatus capable engaging an automatic document feeder proceeds a scan by document feeding type, an adjustment apparatus of image retrieving unit makes an appropriate displacement movement to adjust the variation of total light-path.

### 1. FIELD OF THE INVENTION

The present invention relates to a kind of scanner that can proceed a platform type scan or a document feeding type scan by an automatic document feeder, especially to a kind of scanner that can apply light-path switching to achieve a platform type scan or a document feeding type scan by automatic document feeder.

### 2. BACKGROUND OF THE INVENTION

The application principle of a scanner is that by an optical apparatus a bundle of light is reflected several times and through lens focused into an image and applying a charge coupled device (CCD Converter) the light signal of image is converted into a digital signal which can be processed by computer. However because the light path for imaging has to be larger than a specific length, if the light path is under a straight line, then the volume of the light-path apparatus may become too big that is contradictory to the current trend of smallness and lightness of today's electronic products. Therefore the light-path design of a scanner in today's industry is: by applying multi-reflection-mirrors and under the principle of constant total light-path, the light, entering into the interior of the light-path apparatus, is reflected several times, in order to effectively reduce the volume of a scanner. Therefore, in the light-path apparatus, the number of reflection mirrors, size, and their inter-corresponding-allocation positions do directly decide the volume and weight of the light-path apparatus and also indirectly influence the whole weight and volume size of the scanner.

Since the single scanning takes lots of time in the prior scanner, so it is inevitable for a person waiting long time for placing document when he has many pieces to scan. Today's electronic products are innovated daily, so an automatic document feeder can be arranged in a prior scanner, provide a document feeding scan, get rid of people's waiting time and enhance the scanning efficiency.

Please refer to FIG. 1(A), which is an embodiment illustration for the optical apparatus of a prior flat-platform-type scanner. A first scanning zone 11, defined in the platform type apparatus 10, is provided for scanning a manuscript 40 by platform type. The platform type scanning apparatus 10 includes: a light source, which can provide light emitting to the manuscript 40 on the first scanning zone 11 to proceed a scanning motion of platform type.

A first supporting seat 60 has a first reflection mirror (M1). A second supporting seat 70 has a second reflection mirror (M2) and a third reflection mirror (M3). The light source 30 connects to the first supporting seat 60 and jointly moves with it. The first reflection mirror (M1), second reflection mirror (M2), and third reflection mirror (M3) can receive the light reflected from the manuscript 20 and further redirect its light path. When the scanner scans by the manner of platform type, the first supporting seat 60 and the second supporting seat 70, driven by a driving apparatus 50, with a 2:1 speed, linearly move within the first scanning zone 11.

An image retrieving unit 80, corresponding to the second supporting seat 70, can receive the reflected and direction changed light and convert it into electronic signals. Wherein the image retrieving unit 80 further comprising: a lens 81, which can receive the reflected, direction changed and transmitted light and focus it at the focus; and a charge coupled device 82, arranged at the focus, can receive the light focused by the lens 81 and convert it into digital signals manageable by computer.

When the scanner proceeds scanning by the platform type, wherein the proceeding path of the light starts from the light source 30, through manuscript 20, M1, M2, M3, and arrives at the image retrieving unit 80.

Please refer to FIG. 1(B), which is an embodiment illustration for a prior scanning apparatus capable of engaging an automatic document feeder. A second scanning zone 21 defined on the platform-typed scanning apparatus 10 and matching with the automatic document feeder 20, scans the manuscript 40a by the manner of platform type. The scanning apparatus capable of engaging an automatic document feeder proceeds the scanning motion of document feeding type by the light provided by a light source and emitting into the transcript 40a placed on the second scanning zone 21, while the first supporting seat 60 and the second supporting seat 70 position still in the second scanning zone 21.

When the scanner proceeds scanning by document feeding type, wherein the proceeding path of the light starts from the manuscript 20a, through M1, M2, M3, and arrives at the image retrieving unit 80.

From here, we may know that the prior scanning apparatus capable with an automatic document feeder needs a provided containing space for the first scanning zone 11 to move horizontally to the second scanning zone 21; i.e. when the automatic document feeder 20 is applied for scanning, its length at least needs to increase an additional ‘L’ (as shown in FIG. 1(B). Therefore, not only are its volume and weight bigger, but also is the cost higher. So, the prior scanner's volume, weight, and cost, etc. are therefore can not be reduced effectively, therefore, under the modern fashion of lightness and smallness for today's various electronics products, the difficult situation on marketing is indeed hard to break through.

### SUMMARY OF THE INVENTION

The main object is to provide an optical apparatus of platform type scanning apparatus capable of engaging an automatic document feeder, which applies the design of changing the optical apparatus of a scanner further by effectively reducing the volume, weight, and cost of prior scanner to reach the application object of lightness and smallness emphasized by today's various electronic products.

To reach above-mentioned object, on a scanning apparatus capable of engaging an automatic document feeder, a first scanning zone is provided for platform type scanning and a second scanning zone is provided for automatic feeder type, comprising:

At least one light source, which can provide the light emitting to a manuscript to proceed the scanning motion.

A first supporting seat, having a first reflection mirror that can receive the light reflected from the manuscript and further redirect its light path.

A second supporting seat, which keeps a proper distance from the first supporting seat. The second supporting seat further comprising: at least one switch-able reflection mirror capable of switching between a first position and a second position, and a plurality of reflection mirrors being provided at proper positions on the second supporting seat.

An image retrieving unit, corresponding to the second supporting seat, can receive the reflected, direction changed and transmitted light and convert it into an electronic signal.

An image retrieving unit adjustment apparatus, which connects with the image retrieving unit and can provide the image retrieving unit with an appropriate displacement movement.

Wherein, when the switch-able reflection mirror is at the first position, the inter-positions and angles' corresponding relationship of the first reflection mirror of the first supporting seat and a plurality of reflection mirrors of the second supporting seat can justly make the light of the light source be through reflecting and changing direction then emit to the image retrieving unit to proceed scanning by platform type; while the switch-able reflection mirror is at the second position, the inter-positions and angle's corresponding relationship of a plurality of reflection mirrors of the second supporting seat can justly make the light of the light source be through reflecting and changing direction then emit to the image retrieving unit to proceed scanning by document feeding type by an automatic document feeder.

Another preferable embodiment, on a scanning apparatus capable of engaging an automatic document feeder, a first scanning zone is provided for platform type, and a second scanning zone is provided for automatic feeder type, comprising:

At least one light source, which can provide the light emitting to a manuscript to proceed the scanning motion.

A first supporting seat, having a first reflection mirror that can receive the light reflected from the manuscript and further redirect its light path.

A second supporting seat, which keeps a proper distance from the first supporting seat. At appropriate positions of the second supporting seat there are a plurality of reflection mirrors are provided.

An image retrieving unit, corresponding to the second supporting seat, can receive the reflected, direction changed and transmitted light and convert it into an electronic signal.

An image retrieving unit adjustment apparatus, which connects with the image retrieving unit and can provide the image retrieving unit with an appropriate vertical displacement movement.

Wherein, when the image retrieving unit adjustment apparatus is at the normal position, the inter-positions and angles' corresponding relationship of the a plurality of reflection mirrors can justly make the light of the light source be through reflecting and changing direction then emit to the image retrieving unit to proceed scanning by platform type; while the image retrieving unit adjustment apparatus moves vertically to a higher position, the inter-positions and angle's corresponding relationship of a plurality of reflection mirrors can justly make the light of the light source be through reflecting and changing direction then emit to the image retrieving unit to proceed scanning by document feeding type by an automatic document feeder.

For your esteemed review committee members to further understand and recognize the purpose, characteristic and function, a detailed description matching with several drawings are presented as following:

### BRIEF DESCRIPTION OF THE DRAWINGS

FIG. 1(A) is an embodiment illustration for an optical apparatus of prior flat-platform-type scanner.

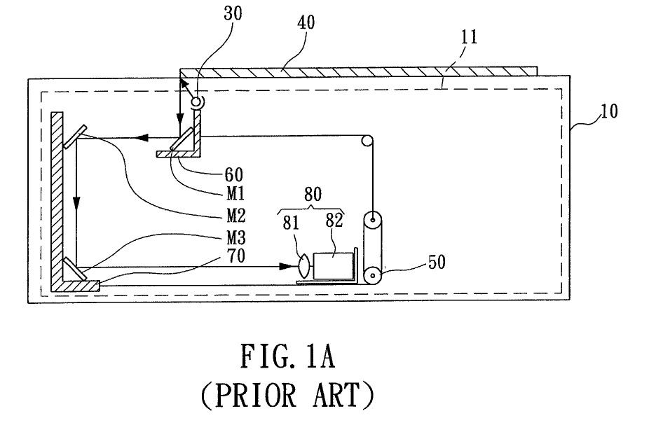

FIG. 1(B) is an embodiment illustration for a scanning apparatus capable of engaging an automatic document feeder.

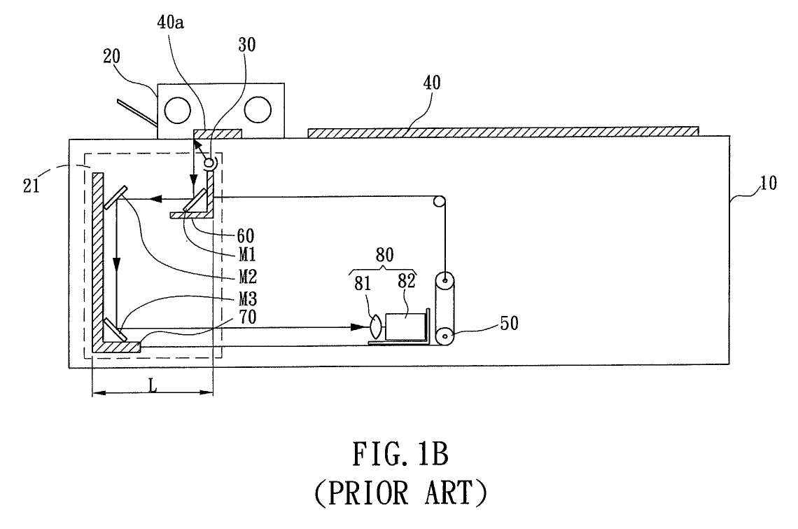

FIG. 2 is an illustration for the first preferable embodiment of a scanning apparatus capable of engaging an automatic document feeder.

FIG. 3 is an illustration for the second preferable embodiment of a scanning apparatus capable of engaging an automatic document feeder.

FIG. 4 is an illustration for the third preferable embodiment of a scanning apparatus capable of engaging an automatic document feeder.

FIG. 5 is an illustration for the fourth preferable embodiment of a scanning apparatus capable of engaging an automatic document feeder.

FIG. 6 is an illustration for the fifth preferable embodiment of a scanning apparatus capable of engaging an automatic document feeder.

FIG. 7 is an illustration for the sixth preferable embodiment of a scanning apparatus capable of engaging an automatic document feeder.

### DETAILED DESCRIPTION OF THE PREFERRED EMBODIMENT

The major characteristic is: because when a scanner additionally has an automatic document feeder, a first supporting seat and a second supporting seat do not need to be moved to another scanning zone to cause the occupation of another space. Relatively, the scanning apparatus capable of engaging an automatic document feeder can be at the original position of platform type scanning and just, by the positions of reflection mirrors and the image retrieving unit adjustment apparatus, an automatic in-focus adjustment is made to adjust the switch of the variation of total light path length and achieve the object of change of light path to suit the arrangement of an automatic document feeder for the proceeding of document feeding scanning and effectively reduce the volume, weight, and cost of prior scanner to achieve the application object of lightness and smallness of today's scanner.

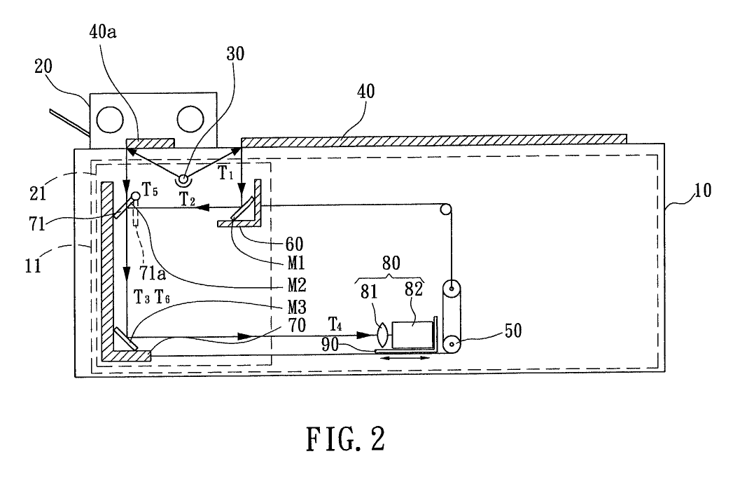

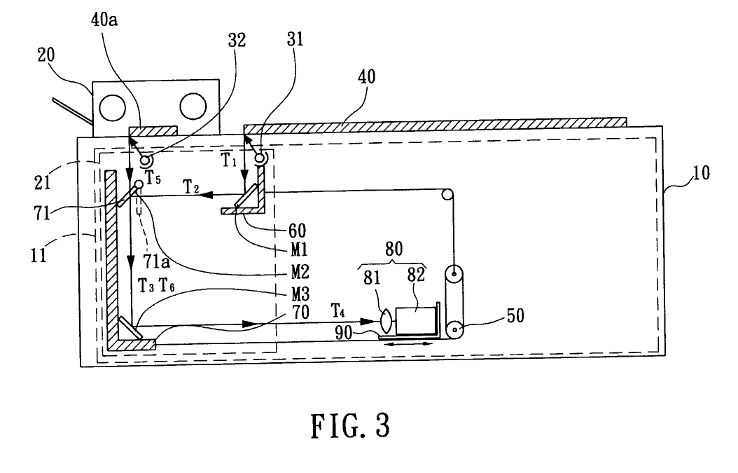

Please refer to FIG. 2 and FIG. 3, which are respectively the first and the second preferable embodiment illustrations of the scanning apparatus capable of engaging an automatic document feeder. The scanning apparatus capable of engaging an automatic document feeder, wherein the platform type scanning apparatus 10 defines a first scanning zone 11 that can scan a manuscript 40 by platform type and a second scanning zone 21 that can match with the automatic document feeder 20 to scan the manuscript 40a by the method of document feeding type. The scanning apparatus capable of engaging an automatic document feeder includes: at least one light source 30, a first supporting seat 60, a second supporting seat 70, an image retrieving unit 80 and an image retrieving unit adjustment apparatus 90.

The light source 30 can make an appropriate switch to provide light emitting to the manuscript 40 of the first scanning zone to proceed the scanning motion of platform type, or switch to provide light emitting to the manuscript 40a of the second scanning zone 21 to proceed the scanning motion of document feeding type (as shown in FIG. 2). Of course, the preferable embodiment is one, and of course can be two or more. In FIG. 3, the light source 30 is two, i.e. a first source 31 and a second light source 32. The first light source 31 can provide light emitting to the manuscript 40 of the first scanning zone 11 to proceed the scanning motion of platform type. The second light source 32 can provide ‘light emitting to the manuscript 40a of the second scanning zone 21 to proceed scanning motion of document feeding type.

The first supporting seat 60 has a first reflection mirror (M1). Which can receive the light reflected from the manuscript 40 and makes it reflect and change direction.

The second supporting seat 70 keeps a proper distance from the first supporting seat 60. The second supporting seat 70 has at least one switch-able reflection mirror. In the preferable embodiments, the switchable reflection mirror is the second reflection mirror (M2) capable of switching between a first position 71 and a second position 71a. The switch-able reflection mirror is a rotate-able type reflection mirror and can be switched to the first position 71 and the second position 71a by rotation method or is a reflection mirror with semi-penetration. When light passes on the front surface, the reflection mirror with semi-penetration can reflect the light. When light passes on the back surface, the reflection mirror with semi-penetration can let it through. And a plurality of reflection mirrors is provided at proper positions of the second supporting seat 70. In the preferable embodiments, the plurality of reflection mirrors is the third reflection mirror (M3).

In the embodiments, when the light source 30 is single (as shown in FIG. 2), the light source 30 is provided at proper position between the first ;supporting seat 60 and the second supporting seat 70. When the light source 30 is two (as shown in FIG. 3), the first light source 31 connects onto the first supporting seat 60 and is driven with it, and the second light source 32 being provided at proper positions on the second supporting seat 70, the automatic document feeder 20, or inside the shell of scanning apparatus.

When scan is proceeded by method of platform type, the first supporting seat 60 and the second supporting seat 70 linearly move with 2:1 speed ratio with the first scanning zone 11 to receive the light reflected from the manuscript 20 and make it reflect and change direction. When scan is proceeded by method of document feeding type by an automatic document feeder, the first supporting seat 60 and the second supporting seat 70 position still.

The image retrieving unit 80, corresponding to the second supporting seat can receive the reflected, direction changed, and transmitted light and convert it into an electronic signal. Wherein the image retrieving unit 80 further includes: a lens 81 that can receive the reflected, direction changed, and transmitted light and focus it at the focus, and a charge coupled device 82 that is arranged at the focus of the lens 81 and can receive the light focused by the lens 81 and convert it into digital signals that can be processed by computer.

The image retrieving unit adjustment apparatus 90 connects with the image retrieving unit 80 and can provide the image retrieving unit 80 to make an appropriate displacement motion.

When scan is proceeded by method of platform type, the second reflection mirror (M2) locates at the first position 71. The light source 30 provides light emitting to the proceeding path of the manuscript 40 of the first scanning zone 11; i.e. the light source 30→the manuscript 40 of the first

scanning zone 11→M1→first position 71 of M2→M3→the image

retrieving unit 80. Wherein the light-path length from the manuscript 40 of the first scanning zone 11 to MI is T₁. The light-path length from M1 to the first position 71 of M2 is T₂. The light-path length from the first position 71 of M2 to M3 is T₃. The light-path length from M3 to the image retrieving unit 80 is T₄. The total light-path length TT₁ is T₁+T₂+T₃+T₄.

When scan is proceeded by method of document feeding type by the automatic document feeder 20, the second reflection mirror (M2) locates at the second position 72. The light source 30 provides light emitting to the proceeding path of the manuscript 40a of the second scanning zone 21; i.e. the light source 30→the manuscript 40a of the second scanning zone 21

→second position 71a of M2→M3→image retrieving unit 80. Wherein

the light-path length from the manuscript 40a of the first scanning zone 21 to the second position 71a of M2 is T₅. The light-path length from the second position 71a of M2 to M3 is T₆. The light-path length from M3 to the image retrieving unit 80 is T₄. The total light-path length TT₂ is T₅+T₆+T₄.

Wherein the total light-path length has a variation, we can overcome it by allowance error (applied in lower level product) or the technique of digital focus-variation. However if when it is corresponding to higher level products or higher quality requirement of scanning, the optical focus-variation lens can be applicable or the image retrieving unit adjustment apparatus 90 provides the image retrieving unit 80 to make an appropriate horizontal displacement motion to adjust the variation of total light-path length. The distance of the horizontal displacement motion is equal to the variation difference distance of total light-path length TT₁−TT₂ that is the length of T₂.

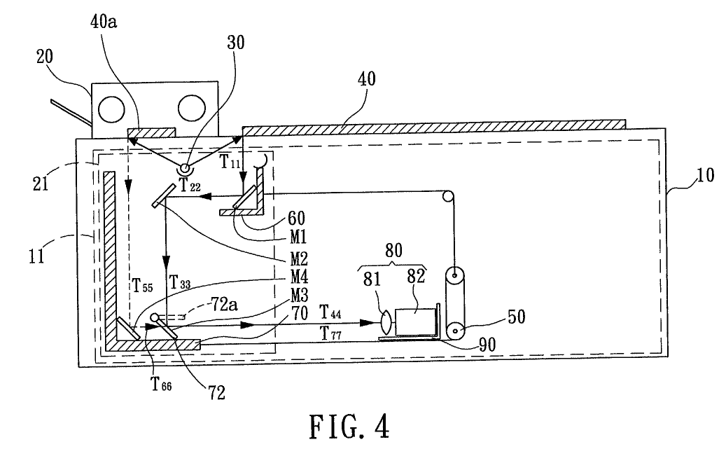

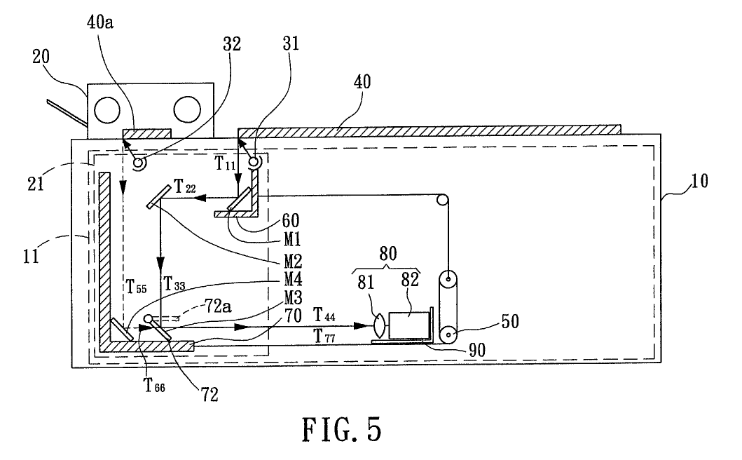

Please refer to FIG. 4 and FIG. 5, which are respectively the third and fourth preferable embodiment illustrations of the scanning apparatus capable of engaging an automatic document feeder. Wherein the difference between these preferable embodiments with the first and second preferable embodiments is the variation of reflection mirrors set. Here the same parts of structure of these preferable embodiments and the first, second preferable embodiments are not described repetitiously.

The first supporting seat 60 has a first reflection mirror (M1). Which can receive the light reflected from the manuscript 40 and makes it reflect and change direction.

The second supporting seat 70 keeps a proper distance from the first supporting seat 60. The second supporting seat 70 has at least one switch-able reflection mirror. In the preferable embodiments, the switchable reflection mirror is the third reflection mirror (M3) capable of switching between a first position 72 and a second position 72a. The switch-able reflection mirror is a rotate-able type reflection mirror and capable of switching the first position 72 and the second position 72a by rotation method or is a reflection mirror with semi-penetration. When light passes on the front surface, the reflection mirror with semi-penetration can reflect the light. When light passes on the back surface, the reflection mirror with semi-penetration can let it through. And a plurality of reflection mirrors is provided at proper positions of the second supporting seat 70. In the preferable embodiments, the plurality of reflection mirrors is the second reflection mirror (M2) and the fourth reflection mirror (M4).

When scan is proceeded by method of platform type, the third reflection mirror (M3) locates at the first position 72. The light source 30 provides light emitting to the proceeding path of the manuscript 40 of the first scanning zone 11; i.e. the light source 30→the manuscript 40 of the first

scanning zone 11→M1→M2→first position 72 of M3→the image

retrieving unit 80. Wherein the light-path length from the manuscript 40 of the first scanning zone 11 to M1 is T₁₁. The light-path length from M1 to M2 is T₂₂. The light-path length from M2 to the first position 72 of M3 is T₃₃. The light-path length from the first position 72 of M3 to the image retrieving unit 80 is T₄₄. The total light-path length TT₃ is T₁₁+T₂₂+T₃₃+T₄₄.

When scan is proceeded by method of document feeding type by an automatic document feeder, the third reflection mirror (M3) locates at the second position 72a. The light source 30 provides light emitting to the proceeding path of the manuscript 40a of the second scanning zone 21; i.e. the light source 30B→the manuscript 40a of the second scanning zone 21→

M4→second position 72a of M3 the image retrieving unit 80. Wherein

the light-path length from the manuscript 40a of the first scanning zone 21 to M4 is T₅₅. The light-path length from M4 to the second position 72a of M3 is T₆₆. The light-path length from the second position 72a of M3 to the image retrieving unit 80 is T₇₇. The total light-path length TT₄ is T₅₅+T₆₆+T₇₇.

Wherein because the variation of the total light-path length is not very large, optical focus-variation lens is applied to the image retrieving unit 80 to make an automatic in-focus adjustment to adjust the variation of the total light-path length. The in-focus adjustment variation is the variation of TT₃−TT₄.

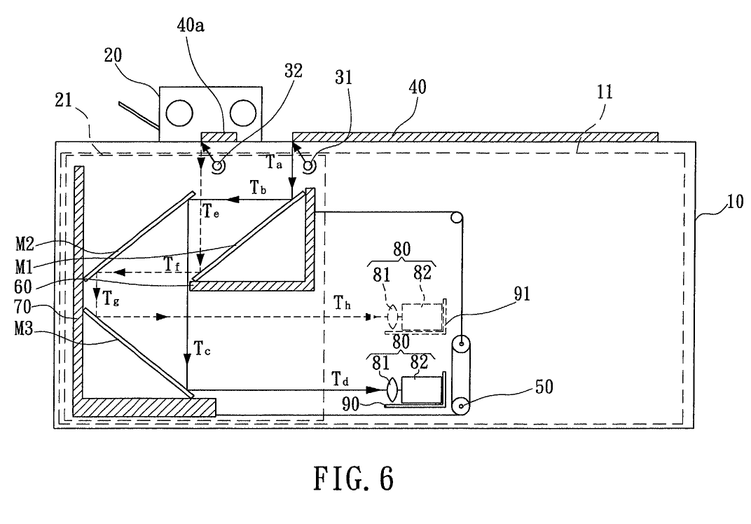

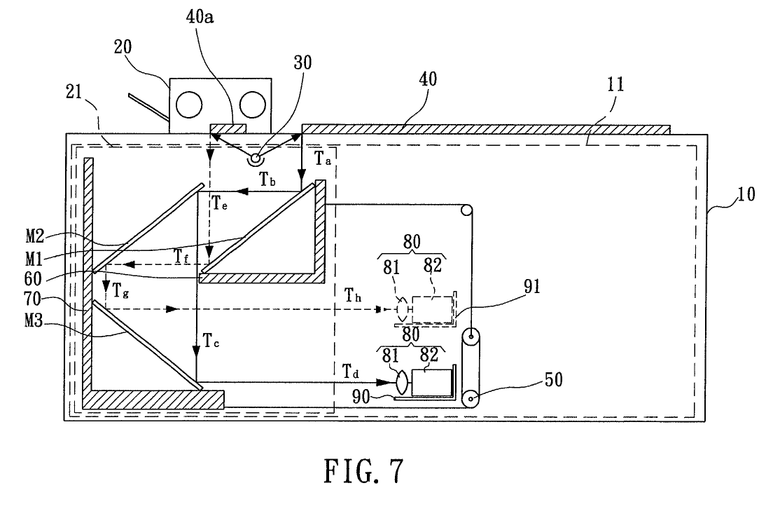

Please refer to FIG. 6 and FIG. 7, which are respectively the fifth and sixth preferable embodiment illustrations of the scanning apparatus capable of engaging an automatic document feeder. Wherein the difference between these preferable embodiments with the first and second preferable embodiments is that the image retrieving unit adjustment apparatus 90 can provide the image retrieving unit 80 to make an appropriately vertical displacement motion, while the second reflection mirror (M2) of the reflection mirror set is the prior reflection mirror. The other structures that is the same as those of the first preferable embodiments are not described more repetitiously.

Wherein the first reflection mirror (M1) locates on the first supporting seat 76. The second reflection mirror (M2) and the third reflection mirror (M3) locate on the second supporting seat 77.

The image retrieving unit adjustment apparatus 90 can locate at normal position or can vertically move to a higher position 91 to receive the reflected, direction changed, and transmitted light and convert it into electronic signals by the image retrieving unit 80.

When scan is proceeded by method of platform type, the image retrieving unit adjustment apparatus 90 locates at the normal position. The light source 30 provides light emitting to the proceeding path of the

manuscript 40 of the first scanning zone 11; i.e. the light source 30→the

manuscript 40 of the first scanning zone 11→M1→M2→M3→the image

retrieving unit 80 (image retrieving unit adjustment apparatus is at normal position). Wherein the light-path length from the manuscript 40 of the first scanning zone 11 to M1 is Tₐ. The light-path length from M1 of the first scanning zone to M2 is T_{b}. The light-path length from M2 of the first scanning zone to M3 is T_{c}. The light-path length from M3 to the image retrieving unit 80 is T_{d}. The total light-path length TT₅ is Tₐ+T_{b}+T_{c}+T_{d}.

When scan is proceeded by method of document feeding type by the automatic document feeder 30, the image retrieving unit adjustment apparatus 90 is vertically moved to a higher position 91. The light source 30 provides light emitting to the proceeding path of the manuscript 40a of

the second scanning zone 21; i.e. the light source 30→the manuscript 40a of

the second scanning zone 21→M1→M2→M3→the image retrieving unit 80

(image retrieving unit adjustment apparatus 90 is at the higher position 91). Wherein the light-path length from the manuscript 40a of the first scanning zone 21 to M1 is Tₑ. The light-path length from M1 of the second scanning zone 21 to the M2 is T_{f}. The light-path length from M2 of the second scanning zone 21 to M3 is T_{g}. The light-path length from M3 to the image retrieving unit 80 (the image retrieving unit adjustment apparatus 90 is at a higher position 91) is Tₕ. The total light-path length TT₅ is Tₑ+T_{f}+T_{g}+Tₕ.

Wherein because the variation of the total light-path length is not very large, optical focus-variation lens is applied to the image retrieving unit 80 to make an automatic in-focus adjustment to adjust the variation of the total light-path length. The in-focus adjustment variation is the variation of TT₃−TT₄.

From the above-mentioned preferable embodiments, we know that applying the variation of light-path and switching the light source 30 without pushing the second supporting seat 70 to farther distance L, the volume, weight, and cost of the prior scanner can be effectively reduced, the modern fashion of lightness and smallness emphasized by today's various electronic products has been achieved and the embarrassing situation on marketing can be broken through.

What is claimed is:

1. A scanning apparatus capable of engaging an automatic document feeder, wherein a first scanning zone is provided for platform type scanning and a second scanning zone is provided for automatic feeder type, comprising:
at least one light source, which can provide the light emitting to a manuscript to proceed the scanning motion;
a first supporting seat, having a first reflection mirror that can receive the light reflected from the manuscript and further redirect its light path;
a second supporting seat, which keeps a proper distance from the first supporting seat, comprising:
at least one switch-able reflection mirror capable of switching between a first position and a second position;
a plurality of reflection mirrors being provided at proper positions on the second supporting seat.
an image retrieving unit, corresponding to the second supporting seat, can receive the reflected, direction changed and transmitted light and convert it into an electronic signal, and
an image retrieving unit adjustment apparatus, which connects with the image retrieving unit and can provide the image retrieving unit with an appropriate displacement movement.
wherein, when the switch-able reflection mirror is at the first position, the inter-positions and angles' corresponding relationship of the first reflection mirror of the first supporting seat and a plurality of reflection mirrors of the second supporting seat can justly make the light of the light source be through reflecting and changing direction then emit to the image retrieving unit to proceed scanning by platform type; while the switch-able reflection mirror is at the second position, the inter-positions and angle's corresponding relationship of a plurality of reflection mirrors of the second supporting seat can justly make the light of the light source be through reflecting and changing direction then emit to the image retrieving unit to proceed scanning by document feeding type by an automatic document feeder.

2. The scanning apparatus capable of engaging an automatic document feeder of claim 1, wherein when scan is proceeded by platform type, the first supporting seat and the second supporting seat with 2:1 speed ration linearly move within the first scanning zone.

3. The scanning apparatus capable of engaging an automatic document feeder of claim 1, wherein when scan is proceeded by document feeding type by an automatic document feeder, the first supporting seat and the second supporting seat position still within the second scanning zone.

4. The scanning apparatus capable of engaging an automatic document feeder of claim 1, wherein the light source is provided at proper position between the supporting seat and the second supporting seat.

5. The scanning apparatus capable of engaging an automatic document feeder of claim 1, wherein the first supporting seat has a first reflection mirror (M1), the second supporting seat has a second reflection mirror (M2) that is a switch-able reflection mirror and a third reflection mirror (M3), the light source provides light emitting to the proceeding path of the
manuscript located in the first scanning zone, the light source→the
manuscript of the first scanning zone→M1→first position of M2→M3→
image retrieving unit; while the light source provide light emitting to the proceeding path of the manuscript located in the second scanning zone, the
light source→the manuscript of the second scanning zone→second
position of M2→M3→image retrieving unit.

6. The scanning apparatus capable of engaging an automatic document feeder of claim 1, wherein the first supporting seat has a first reflection mirror (M1), the second supporting seat has a second reflection mirror (M2), a third reflection mirror (M3) that is a switch-able reflection mirror and a fourth reflection mirror (M4), the light source provides light emitting to the proceeding path of the manuscript located in the first scanning zone,
the first light source→the manuscript of the first scanning zone→M1→M2
→first position of M3→image retrieving unit; while the second light
source provide light emitting to the proceeding path of the manuscript located in the second scanning zone, the light source→the manuscript of the second scanning zone→M4→second position of M3→image retrieving unit.

7. The scanning apparatus capable of engaging an automatic document feeder of claim 1, wherein the switch-able reflection mirror is a rotate-able reflection mirror capable of switching to the first position and the second position by rotation method.

8. The scanning apparatus capable of engaging an automatic document feeder of claim 1, wherein the switch-able reflection mirror is a reflection mirror with semi-penetration; when light passes on the front surface, the reflection mirror with semi-penetration reflects the light; when light passes on the back surface, the reflection mirror with semi-penetration lets the light pass through.

9. The scanning apparatus capable of engaging an automatic document feeder of claim 1, wherein the image retrieving unit further comprising:
a lens, which can receive the reflected, direction changed, and transmitted light and focus it at the focus; and
a charge coupled device, provided at the focus of the lens, can receive the light focused by the lens and convert it into digital signal that can be processed by computer.

10. The scanning apparatus capable of engaging an automatic document feeder of claim 1, wherein the image retrieving unit adjustment apparatus makes a horizontal displacement movement to adjust the variation of the total light-path length.

11. The scanning apparatus capable of engaging an automatic document feeder of claim 1, wherein the image retrieving unit adjustment apparatus makes an automatic in-focus adjustment to adjust the variation of the total light-path length.

12. A scanning apparatus capable of engaging an automatic document feeder, wherein a first scanning zone is provided for platform type scanning and a second scanning zone is provided for automatic feeder type, comprising:
at least one light source, which can provide the light emitting to a manuscript to proceed the scanning motion;
a first supporting seat, having a first reflection mirror that can receive the light reflected from the manuscript then reflect it and further redirect its light path.
a second supporting seat, which keeps a proper distance from the first supporting seat, at appropriate positions of the second supporting seat there are a plurality of reflection mirrors are provided.
an image retrieving unit, corresponding to the second supporting seat, can receive the reflected, direction changed and emitting light and convert it into an electronic signal, and,
an image retrieving unit adjustment apparatus, which connects with the image retrieving unit and can provide the image retrieving unit with a proper vertical displacement movement.
wherein, when the image retrieving unit adjustment apparatus is at the normal position, the inter-positions and angles' corresponding relationship of the a plurality of reflection mirrors can justly make the light of the light source be through reflecting and changing direction then emit to the image retrieving unit to proceed scanning by platform type; while the image retrieving unit adjustment apparatus moves vertically to a higher position, the inter-positions and angle's corresponding relationship of a plurality of reflection mirrors can justly make the light of the light source be through reflecting and changing direction then emit to the image retrieving unit to proceed scanning by document feeding type by an automatic document feeder.

13. The scanning apparatus capable of engaging an automatic document feeder of claim 12, wherein when scan is proceeded by platform type, the first supporting seat and the second supporting seat with 2:1 speed ration linearly move within the first scanning zone.

14. The scanning apparatus capable of engaging an automatic document feeder of claim 12, wherein when scan is proceeded by document feeding type by an automatic document feeder, the first supporting seat and the second supporting seat position still.

15. The scanning apparatus capable of engaging an automatic document feeder of claim 12, wherein the light source is provided at proper position between the supporting seat and the second supporting seat.

16. The scanning apparatus capable of engaging an automatic document feeder of claim 12, wherein the first supporting seat has a first reflection mirror (M1), the second supporting seat has a second reflection mirror (M2) and a third reflection mirror (M3), the light source provides light emitting to the proceeding path of the manuscript located in the first scanning zone, the light source-the manuscript of the first scanning
zone→M1→M2→M3→image retrieving unit (image retrieving unit
adjustment apparatus is at normal position); while the light source provide light emitting to the proceeding path of the manuscript located in the second scanning zone, the light source→the manuscript of the second
scanning zone→M1→M2→M3→image retrieving unit (image retrieving
unit adjustment apparatus is at higher position).

17. The scanning apparatus capable of engaging an automatic document feeder of claim 12, wherein the image retrieving unit further comprising:
a lens, which can receive the reflected, direction changed, and transmitted light and focus it at the focus; and
a charge coupled device, provided at the focus of the lens, can receive the light focused by the lens and convert it into digital signal that can be processed by computer.

18. The scanning apparatus capable of engaging an automatic document feeder of claim 12, wherein the image retrieving unit adjustment apparatus makes an automatic in-focus adjustment to adjust the variation of the total light-path length.
